(19) United States
(12) Patent Application Publication
(10) Pub. No.: US 2012/0008896 A1
(43) Pub. Date: Jan. 12, 2012

(54) INTEGRATED OPTICS MODULE FOR MULTIPLEX TRANSCEVIER

(75) Inventors: Ming-Chang Lee, Hsinchu City (TW); Kai-Ning Ku, Hsinchu (TW); Chung-Yung Wang, New Taipei City (TW); Kuo-Chung Huang, Taoyuan County (TW); Tsung-Chi Hsu, New Taipei City (TW); Chung-Hsin Fu, Taoyuan County (TW); Lin-Yu Tai, Kaohsiung City (TW)

(73) Assignee: NATIONAL TSING-HUA UNIVERSITY, Hsinchu (TW)

(21) Appl. No.: 13/157,419

(22) Filed: Jun. 10, 2011

(30) Foreign Application Priority Data
Jul. 7, 2010 (TW) 099122306

(51) Int. Cl. G02B 6/125

(52) U.S. Cl. 385/14

(57) ABSTRACT

The present invention relates to an integrate optics for multiplexer transceiver module, comprising: a substrate, a multiplexer, a first waveguide coupling device, a second waveguide coupling device and a third waveguide coupling device. In the present invention, the semiconductor materials and the semiconductor process are used to integrate variety of optical devices on a single semiconductor substrate (chip) by way of modular design and miniaturization, so as to carry out an integrated optics communication framework with high efficiency and low cost. Moreover, in the present invention, a plurality of optical receivers are integrated on the substrate by means of flip-chip bonding, so that, not only the objective of integrating the optical devices is accomplished but also the intensity of laser optical signal is increased.

### BACKGROUND OF THE INVENTION

1. Technical Field

The present invention relates to an optics module for multiplex transceiver, and more particularly, to an integrated optics module for multiplex transceiver, in which a variety of optical devices are integrated on a single semiconductor substrate (chip) by way of modular design and miniaturization.

2. Description of Related Art

In recent years, since the advancement of network and information transmission, the transmission volume of data completed through Internet has been obviously increased; thus, the traditional data transmission way carry out by a coaxial cable is inadequate for high data throughput. However, compared with the coaxial cable, fibers have multi advantages, such as: high communication capacity, small signal loss, anti-electromagnetic interference, light weight, and small size; therefore, the fiber has been became the main instrument used in internet data transmission.

Generally, an optical signal (i.e., a light) with a specific wave length is adopted for loading an information channel when the fiber transmits data; however, based on the limitation of the optical modulation, the available bandwidth of the fiber is wasted if the fiber only provides one information channel for transmitting data. For this reason, the framework of wavelength division multiplexing (WDM) is proposed and applied in broadband communication, in addition, the WDM also used in optical signal switch and optical signal process based on the property of the different information channels being loaded by different optical wave lengths. So that, under the present optical transmission system, how to effectively save the establishing cost of the optical transmission system becomes an important issue needed to be resolved.

According to the above issue, a bi-directional multiplexer with waveguide coupling devices is proposed. Referring to FIG. 1, which illustrates a stereo view of the bi-directional multiplexer with waveguide coupling devices, as shown in FIG. 1, bi-directional multiplexer 1′ includes: a duplex device 11′, a first single mode waveguide 12′, a second single mode waveguide 13′, a third single mode waveguide 14′, and a fourth single mode waveguide 15′, wherein when a second optical signal (light)λ2′ is transmitted to the second single mode waveguide 13′, the second optical signal λ2′ enters the duplex device 11′ and is further outputted via the fourth single mode waveguide 15′; Moreover, when a first optical signal (light) λ1′ is transmitted to the fourth single mode waveguide 15′, the first optical signal (light) λ1′ enters the duplex device 11′ and is further outputted through the third single mode waveguide 14′.

Please refer to FIG. 2, which illustrates the top view of the bi-directional multiplexer with waveguide coupling devices 1′. As shown in FIG. 2, the fourth single mode waveguide 15′ is connected to a fiber 2′ for receiving the first optical signal λ1′. The second single mode waveguide 13′ is connected to a light-emitting device 3′ for receiving the second optical signal λ2′. The third single mode waveguide 14′ is connected to a first light-receiving device 4′, so that the first light-receiving device 4′ is able to receive the first optical signal λ1′ outputted by the third single mode waveguide 14′. Generally, as shown in FIG. 2, the light-emitting device 3′ must be further connected with a second light-receiving device 5′ for receiving the partial second optical signal λ2′, so as to monitor the condition of the light-emitting device 3′.

The above-mentioned optical communication framework of the bi-directional multiplexer with waveguide coupling devices 1′ is a kind of planar waveguide circuit (PLC) of optics transceiver module, wherein a variety of optical devices are fabricated and miniaturized by using semiconductor materials and semiconductor processing technology; however, the bi-directional multiplexer 1′ still has the shortcomings and the drawbacks as follows:

1. The light-emitting device 3′ and the bi-directional multiplexer 1′ are not integrally manufactured. According to the above description, it knows that the light-emitting device 3′ is packaged with the second single mode waveguide 13′ after completing the fabrication of the bi-directional multiplexer 1′; However, when packaging the light-emitting device 3′ to the bi-directional multiplexer 1′, the second single mode waveguide 13′ often not be aligned well to the light-emitting surface of the light-emitting device 3′ due to the influence caused by external factors, so that the second single mode waveguide 13′ can not completely receive the second optical signal λ2′ from the light-emitting device 3′.
2. Inheriting to above point 1, since the bi-directional multiplexer with waveguide coupling devices 1′, the light-emitting device 3′ has to be both well aligned to the second single mode waveguide 13′ and the second light-receiving device 5′; So that, it increases the difficulty in optical package. Meanwhile, the second light-receiving device 5′ usually receive light from device surface while the second single mode waveguide 13′ received light from device edge; this inconsistency make the package more difficult.
3. The first single mode waveguide 12′ is not connected to any optical devices or optical communication devices, thus, the bi-directional multiplexer with waveguide coupling devices 1′ has the disadvantage of incomplete utilization due to the first single mode waveguide 12′ is left to be unused.
4. Inheriting to above point 1, for the conventional technology, the monitoring device (i.e., the second light-receiving device 5′) used for monitoring whether the light-emitting device 3′ normally works is commonly disposed behind the light-emitting device 3′, so that the light-emitting device 3′ connected with the second single mode waveguide 13′ has to split evenly optical power to the second light-receiving device 5′; for this reason, the light emitted to the second single mode waveguide 13′ has the problem of insufficient power.

Thus, according to above descriptions, it knows the bi-directional multiplexer with waveguide coupling devices 1′ still has the shortcomings and the drawbacks; besides, for the conventional bulk optics transceiver modules, it not integrates variety of devices, such as the optical devices, the light-emitting device, the light-receiving device, and the metal electrode, on a single substrate (chip); so that, it is easily to aware of that the conventional bulk optics transceiver modules not includes a complete integrated optics transceiver module.

Accordingly, in view of the conventional optical communication framework of the bi-directional multiplexer with waveguide coupling devices still has shortcomings and drawbacks, the inventor of the present application has made great efforts to make inventive research thereon and eventually provided an integrated optics module for multiplex transceiver.

### BRIEF SUMMARY OF THE INVENTION

The primary objective of the present invention is to provide an integrated optics module for multiplex transceiver, in which a variety of optical devices are integrally fabricated on a single semiconductor substrate (chip) by way of modular design and miniaturization, so that a integrated optical communication framework with the properties of high efficiency and low cost is carried out.

Accordingly, to achieve the abovementioned primary objective, the inventor proposes an integrated optics module for multiplex transceiver, comprising: a substrate, a multiplexer, a first waveguide coupling device, and a second waveguide coupling device.

The multiplexer is formed on the substrate and used to transmit at least two optical signals with different wavelengths. The multiplexer comprises: a duplex device; a first waveguide, one end of the first waveguide is connected to the duplex device and another end thereof is connected to a fiber for receiving a first optical signal; a second waveguide, one end of the second waveguide is connected to the duplex device, wherein a second optical signal is able to enter the duplex device through the other end of the second waveguide and propagates to the first waveguide via the duplex device, furthermore, the second optical signal being transmitted to the fiber through the first waveguide; a third waveguide, which is connected to the duplex device, wherein after the first optical signal is transmitted into the duplex device via the first waveguide, the first optical signal is outputted through the third waveguide; and a fourth waveguide, which is connected to the duplex device, wherein a partial second optical signal is outputted through the fourth waveguide for being a monitor signal.

The first waveguide coupling device is formed on the substrate and connected to the second waveguide, so that, through the first waveguide coupling device, the second optical signal can be efficiently coupled into the second waveguide. The second waveguide coupling device is formed on the substrate and connected to the fourth waveguide, such that the partial second optical signal may be efficiently outputted via the second waveguide coupling device. The third waveguide coupling device is formed on the substrate and connected to the third waveguide, such that the first optical signal may be efficiently outputted via the third waveguide coupling device.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a stereo view of a bi-directional multiplexer with waveguide coupling devices;

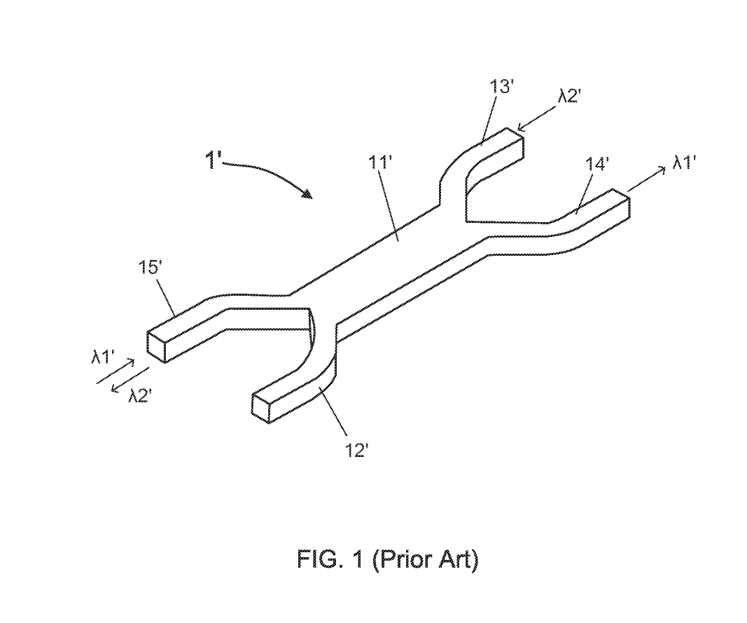

FIG. 2 is a top view of the bi-directional multiplexer with the waveguide coupling devices;

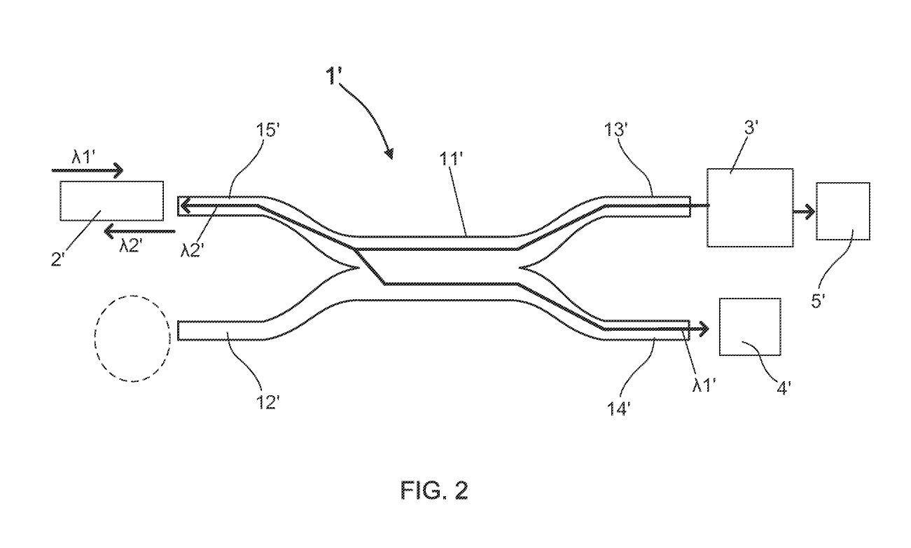

FIG. 3 is the top view of an integrated optics module for multiplex transceiver according to the present invention; and

FIG. 4 is the top view of the integrated optics module for multiplex transceiver with a variety of optical devices.

### DETAILED DESCRIPTION OF THE INVENTION

To more clearly describe an integrated optics module for multiplex transceiver according to the present invention, embodiments of the present invention will be described in detail with reference to the attached drawings hereinafter.

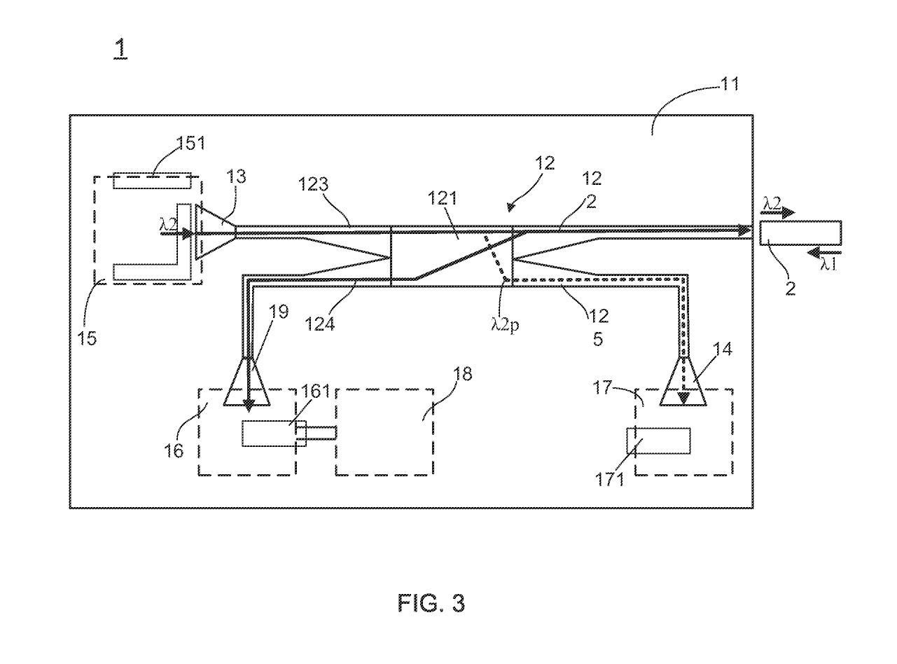

Please refer to FIG. 3, which illustrates a top view of the integrated optics module for multiplex transceiver according to the present invention. As shown in FIG. 3, the integrated optics module for multiplex transceiver 1 includes: a substrate 11, a multiplexer 12, a first waveguide coupling device 13, a second waveguide coupling device 14, a third waveguide coupling device 19, a first optical device district 15, a second optical device district 16, and a third optical device district 17, wherein the substrate 11 can be a semiconductor substrate or a compound semiconductor substrate.

The multiplexer 12 is formed on the substrate 11, wherein the manufacturing material of the multiplexer 12 can be a semiconductor material, polymer, silica, or a compounded semiconductor material; however, in the embodiment of the integrated optics module for multiplex transceiver 1, the manufacturing material of the multiplexer 12 is silica. The multiplexer 12 is used to transmit at least two optical signals with different wave lengths, which includes: a duplex device 121, capable of transmitting the at least two optical signals by way of interference effect; a first waveguide 122, one end of the first waveguide 122 is connected to the duplex device 121 and another end thereof is connected to an external fiber 2 for receiving a first optical signal λ1; a second waveguide 123, one end of the second waveguide 123 is connected to the duplex device 121, wherein a second optical signal is able to enter the duplex device 121 through the other end of the second waveguide 123 and propagates to the first waveguide 122 via the duplex device 121, furthermore, the second optical signal λ2 is transmitted to the fiber 2 through the first waveguide 122; a third waveguide 124, which is connected to the duplex device 121 and the third coupling waveguide coupling device 19, wherein after the first optical signal λ1 is transmitted into the duplex device 121 via the first waveguide 122, the first optical signal λ1 is outputted through the third waveguide 124; and a fourth waveguide 125, which is also connected to the duplex device 121, wherein a partial second optical signal λ2p is outputted through the fourth waveguide 125 for being a monitor signal.

The first waveguide coupling device 13 is formed on the substrate 11, wherein the manufacturing material of the first waveguide coupling device 13 can be a semiconductor material, polymer, silica, or a compound semiconductor material; however, the same to the duplex device 121, in the embodiment of the integrated optics module for multiplex transceiver 1, the manufacturing material of the first waveguide coupling device 13 is silica. Moreover, as shown in FIG. 3, the first waveguide coupling device 13 is connected to the second waveguide 123, so that, through the first waveguide coupling device 13, the second optical signal can be efficiently coupled into the second waveguide 123.

The second waveguide coupling device 14 is formed on the substrate 11, wherein the manufacturing material of the second waveguide coupling device 14 can be a semiconductor material, polymer, silica, or a compound semiconductor material; however, the same to the first waveguide coupling device 13, in the embodiment of the integrated optics module for multiplex transceiver 1, the manufacturing material of the second waveguide coupling device 14 is silica.

The third waveguide coupling device 19 is formed on the substrate 11, wherein the manufacturing material of the third waveguide coupling device 19 can be a semiconductor material, polymer, silica, or a compound semiconductor material; however, the same to the first waveguide coupling device 13, in the embodiment of the integrated optics module for multiplex transceiver 1, the manufacturing material of the second waveguide coupling device 19 is silica.

Moreover, as shown in FIG. 3, the second waveguide coupling device 14 is connected to the second waveguide 125, therefore, the partial second optical signal λ2p can be efficiently outputted by the second waveguide coupling device 14.

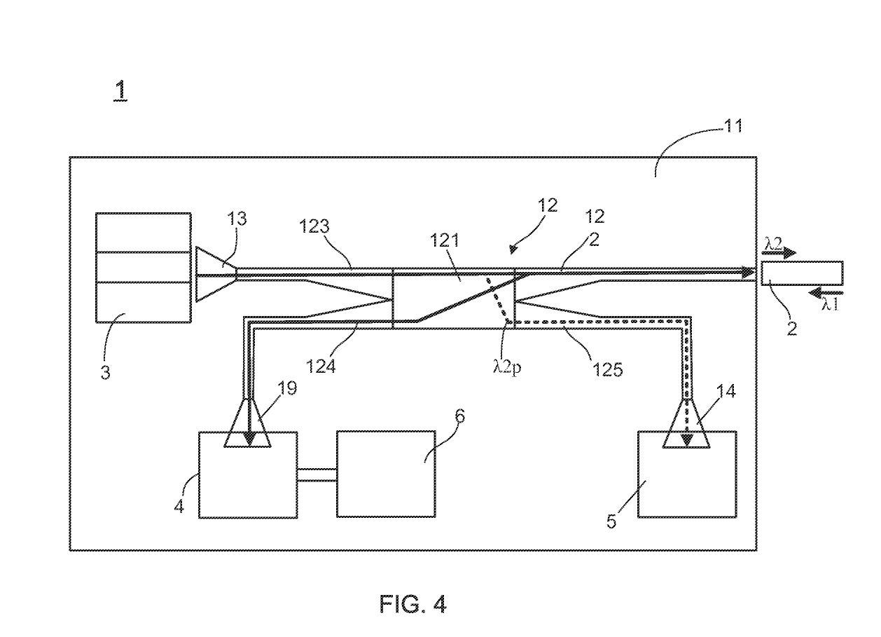

Referring to FIG. 3 again, and simultaneously referring to FIG. 4, which illustrates the top view of the integrated optics module for multiplex transceiver with a variety of optical devices. As shown in FIG. 3, a first optical device district 15 is formed on the substrate 11 and adjacent to the first waveguide coupling device 13, and as shown in FIG. 4, a first optical device 3 is disposed on the first optical device district 15. In the embodiment of the integrated optics module for multiplex transceiver 1, the first optical device 3 is a distributed feedback laser (DFB), which is a kind of light-emitting device and able to emit the second optical signal λ2. However, when manufacturing the integrated optics module for multiplex transceiver 1, the first optical device 3 is not confined to be the distributed feedback laser. The first optical device 3 is disposed on the first optical device district 15 by way of flip-chip bonding, so that the integrated optical devices carries out and the intensity and energy of the laser signal (i.e., the second optical signal λ2) can be increased. Moreover, the first optical device district 15 has a plurality of first electrodes 151, thus, through the first electrodes 151, the first optical device 3 disposed on the first optical device district 15 is able to be biased.

As shown in FIG. 3, the second optical device district 16 is formed on the substrate 11 and adjacent to the third waveguide 124 and the third waveguide coupling device 19, and as shown in FIG. 4, a second optical device 4 is disposed on the second optical device district 16. In the embodiment of the integrated optics module for multiplex transceiver 1, the second optical device 4 is an avalanche photodiode (APD), which is a kind of light-receiving device. However, when manufacturing the integrated optics module for multiplex transceiver 1, the second optical device 4 is not confined to be the avalanche photodiode. The same to first optical device 3, the second optical device 4 is disposed on the second optical device district 16 by way of the flip-chip bonding. Moreover, the second optical device district 16 has at least one second electrode 161, so that the second optical device 4 disposed on the second optical device district 16 is able to be biased via the second electrode 161 and receive the first optical signal λ1. In this embodiment, when the first optical signal λ1 is outputted from the third waveguide 124 and the third waveguide coupling device 19, the first optical signal λ1 would be reflected by an slant waveguide layer opposite to the third waveguide coupling device 1, therefore, the first optical signal λ1 deflects into the second optical device 4 (i.e., the APD) by an incidence angle of 54.7°; in addition, the second optical device 4 receives the first optical signal λ1 by way of surface coupling.

The third optical device district 17 is formed on the substrate 11 and adjacent to the second waveguide coupling device 14, as shown in FIG. 4, a third optical device 5 is disposed on the third optical device district 17. In the embodiment of the integrated optics module for multiplex transceiver 1, the third optical device 5 is a P-Intrinsic-N diode (PIN diode), which is also a kind of light-receiving device used for receiving the monitor signal. So that, when the partial second optical signal λ2p is outputted from the fourth waveguide 125 and the second waveguide coupling device 14, the partial second optical signal λ2p would also be reflected by the slant waveguide layer opposite to the second waveguide coupling device 14, therefore, the partial second optical signal λ2p deflects into the third optical device 5 (i.e., the PIN diode) by the incidence angle of 54.7°; similarly, the third optical device 5 receives the partial second optical signal λ2p by way of surface coupling. Thus, by way of using the PIN diode to receive the monitor signal, it is able to determine whether the first optical device 3 normally works. Similarly, when manufacturing the integrated optics module for multiplex transceiver 1, the third optical device 5 is not confined to be the PIN diode. Moreover, the same to the first optical device 3 and the second optical device 4, the third optical device 5 is disposed on the third optical device district 17 by way of the flip-chip bonding. The third optical device district 17 further includes at least one third electrode 171, therefore, the third optical device 5 can gets the bias via the third electrode 171 and receive the partial second optical signal λ2p.

The shape of the electrodes disposed on the first optical device district 15, the second optical device district 16 and the third optical device district 17 must to be adequately designed according to the appearance of the optical devices. In this embodiment, the shape of the first electrodes 151, the second electrode 161 and the third electrode 171 are specifically designed and respectively formed on the first optical device district 15, the second optical device district 16 and the third optical device district 17. Therefore, when the first optical device 3, the second optical device 4 and the third optical device 5 are respectively disposed on the first optical device district 15, the second optical device district 16 and the third optical device district 17, the first electrodes 151, the second electrode 161 and the third electrode 171 can connect with the junction electrodes of the first optical device 3, the second optical device 4 and the third optical device 5.

Please refer to FIG. 3 and FIG. 4 again, the embodiment of the integrated optics module for multiplex transceiver 1 further includes: a first electronic device district 18, which is formed on the substrate 11 and adjacent to the third optical device district 17. As shown in FIG. 4, the first electronic device district 18 is used for disposing an electronic device 6, so as to make electronic device 6 able to couple with the third optical device 5. The electronic device 6 is a transimpedance amplifier (TIA); however, when manufacturing the integrated optics module for multiplex transceiver 1, the electronic device 6 is not confined to be the transimpedance amplifier. When the first optical signal λ1 is received and converted to a current signal by the avalanche photodiode (second optical device 4), the transimpedance amplifier (electronic device 6) amplifies the current signal.

Moreover, the integrated optics module for multiplex transceiver 1 of the present invention can also be fabricated by way of following semiconductor manufacturing steps:

Firstly, executing step (1), fabricating a polymer with optical properties to a model of the integrated optics for multiplex transceiver 1, wherein the integrated optics for multiplex transceiver 1 is made by way of the semiconductor materials and the semiconductor processing technology; next proceeding to step (2), coating a poly-dimethylsiloxane (PDMS) on the model, so as to get a mold used for manufacturing the integrated optics for multiplex transceiver 1. After the mold is obtained, the manufacturing steps next proceeded to step (3), spinning coating the polymer on the substrate 11; then, proceeding to step (4), using the mold to imprint the polymer for directly making a polymer optics device, wherein the polymer optics device is the same to the integrated optics for multiplex transceiver 1; and then, proceeding to step (5), plating a plurality of electrodes on the substrate 11; finally, executing step (6), disposing the first optical device 3, the second optical device 4, the third optical device 5, and the electronic device 6 on the electrodes of the substrate 11; Therefore, the integrated optics for multiplex transceiver 1 has been manufactured, wherein the integrated optics for multiplex transceiver 1 is a kind of polymer optics device.

Thus, through the above descriptions, the integrated optics for multiplex transceiver of the present invention has been disclosed completely and clearly; in summary, the present invention has the following advantages:

1. In the present invention, the multiplexer, the first waveguide coupling device, the second waveguide coupling device, and the third waveguide coupling device are fabricated on a single substrate, moreover, the first optical device, the second optical device, the third optical device, and the electronic device are also integrated on the single substrate, so that integrated optics for multiplex transceiver is established.
2. Inheriting to above point 1, the material of the optical devices used to constitute the integrated optics for multiplex transceiver can be all the semiconductor materials, moreover, by way of the semiconductor processing technology, the optical devices are integrally manufactured; thus, it is easily to know that the manufacturing cost of the integrated optics for multiplex transceiver is low.
3. The substrate includes the optical device districts, so that, the distributed feedback laser (the first optical device) can be accurately disposed on the first optical device district, furthermore, the first waveguide coupling device is able to completely receive the first optical signal emitted by the distributed feedback laser.
4. Differing from the conventional optical communication framework of the bi-directional multiplexer with waveguide coupling devices, in the present invention, the avalanche photodiode (second optical device) is disposed on the second optical device district for receiving the partial second optical signal (λ2p) by way of the flip-chip bonding; Thus, since the distributed feedback laser emits optical signal by single light-emitting edge, thereof, the problem about that the optical signal is insufficient power has been solved; moreover, the avalanche photodiode can completely receive the partial second optical signal (λ2p) for monitoring and determining whether the distributed feedback laser normally works.

The above description is made on embodiments of the present invention. However, the embodiments are not intended to limit scope of the present invention, and all equivalent implementations or alterations within the spirit of the present invention still fall within the scope of the present invention.

We claim:

1. An integrated optics module for multiplex transceiver, comprising:
a substrate;
a multiplexer, being formed on the substrate and used to transmit at least two optical signals with different wave lengths, the multiplexer comprising:
a duplex device;
a first waveguide, one end of the first waveguide being connected to the duplex device and another end thereof being connected to an external fiber for receiving a first optical signal;
a second waveguide, one end of the second waveguide being connected to the duplex device, wherein a second optical signal is able to enter the duplex device through the other end of the second waveguide and propagates to the first waveguide via the duplex device, furthermore, the second optical signal being transmitted to the fiber through the first waveguide;
a third waveguide, being connected to the duplex device, wherein after the first optical signal is transmitted into the duplex device via the first waveguide, the first optical signal being outputted through the third waveguide; and
a fourth waveguide, being connected to the duplex device, wherein a partial second optical signal is outputted through the fourth waveguide for being a feedback signal;
a first waveguide coupling device, being formed on the substrate and connected to the second waveguide, so that, through the first waveguide coupling device, the second optical signal can be efficiently coupled into the second waveguide; and
a second waveguide coupling device, being formed on the substrate and connected to the fourth waveguide, such that the partial second optical signal may be efficiently outputted via the second waveguide coupling device.
a third waveguide coupling device, being formed on the substrate and connected to the third waveguide, such that the first optical signal λ1 may be efficiently outputted via the third waveguide coupling device.

2. The integrated optics module for multiplex transceiver of claim 1, further comprising:
a first optical device district, being formed on the substrate and adjacent to the first waveguide coupling device for disposing a first optical device, wherein the first optical device district has a plurality of first electrodes, so that, through the first electrodes, the first optical device is able to be biased;
a second optical device district, being formed on the substrate and adjacent to the third waveguide for disposing a second optical device, wherein the second optical device district has at least one second electrode, such that the second optical device can be biased via the second electrode; and
a third optical device district, being formed on the substrate and adjacent to the second waveguide coupling device for disposing a third optical device, wherein the third optical device district has at least one third electrode, thus, by way of the third electrode, the third optical device may be biased.

3. The integrated optics module for multiplex transceiver of claim 2, further comprising a first electronic device district, which is formed on the substrate and adjacent to the third optical device district for disposing an electronic device, so that, when being disposed on the first electronic device district, the electronic device being coupled to the third optical device.

4. The integrated optics module for multiplex transceiver of claim 1, wherein the substrate is selected from the group consisting of: a semiconductor substrate, a polymer substrate, a silica substrate, and a compounded semiconductor substrate.

5. The integrated optics module for multiplex transceiver of claim 1, wherein the material of the multiplexer is selected from the group consisting of: a semiconductor material, a polymer, silica, and a compounded semiconductor material.

6. The integrated optics module for multiplex transceiver of claim 1, wherein the first waveguide coupling device is a taped waveguide coupling device and the fabricating material thereof is a semiconductor material, a polymer, silica, or a compounded semiconductor material.

7. The integrated optics module for multiplex transceiver of claim 1, wherein the second waveguide coupling device is a taped waveguide coupling device and the fabricating material thereof is a semiconductor material a polymer, silica, or a compounded semiconductor material.

8. The integrated optics module for multiplex transceiver of claim 2, wherein the first optical device is a light-emitting device.

9. The integrated optics module for multiplex transceiver of claim 2, wherein the second optical device is an optical signal receiving device.

10. The integrated optics module for multiplex transceiver of claim 2, wherein the third optical device is an optical signal receiving device.

11. The integrated optics module for multiplex transceiver of claim 3, wherein the electronic device is an amplifier.
